(19) United States
(12) Patent Application Publication
(10) Pub. No.: US 2020/0098531 A1
(43) Pub. Date: Mar. 26, 2020

(54) Electrical Contact System

(71) Applicant: Tyco Electronics (Shenzhen) Co. Ltd, Shenzhen (CN)

(72) Inventors: Xiaoning Zhang, Shenzhen (CN); Teng Zou, Shenzhen (CN)

(73) Assignee: Tyco Electronics (Shenzhen) Co. Ltd, Shenzhen (CN)

(21) Appl. No.: 16/698,495

(22) Filed: Nov. 27, 2019

Related U.S. Application Data
(63) Continuation of application No. PCT/EP2018/064350, filed on May 31, 2018.

(30) Foreign Application Priority Data
Jun. 1, 2017 (CN) 201710403473.X

(51) Int. Cl. H01H 9/32; H01H 1/20

(52) U.S. Cl. CPC H01H 9/32; H01H 1/20

(57) ABSTRACT

An electrical contact system includes: a static contact, a movable contact and an arc extinguishing device. The arc extinguishing device includes an arc extinguishing member and a driving mechanism for moving the arc extinguishing member. When the movable contact is moved to the switch-on position, the arc extinguishing member is moved beyond the contact area between the movable contact and the static contact so as to allow the movable contact to be in electrical contact the static contact; and when the movable contact is moved to the switch-off position, the arc extinguishing member is moved into the contact area between the movable contact and the static contact such that the movable contact is electrically isolated from the static contact to cut off the electric arc between the movable contact and the static contact. The arc extinguishing member may be driven by the driving mechanism to be quickly moved into the contact area between the movable contact point and the static contact point.

### CROSS-REFERENCE TO RELATED APPLICATIONS

This application claims the benefit of the Chinese Patent Application No. 201710403473.X filed on Jun. 1, 2017 in the State Intellectual Property Office of China and entitled with “Electrical Contact System”, the whole disclosure of which is incorporated herein by reference.

### TECHNICAL FIELD

At least one embodiment of the present disclosure relates to an electrical contact system, and in particular, to an electrical contact system having an arc extinguishing device.

### BACKGROUND

An electrical contact in an electric switch device and the control appliance may discharge and generate an electric arc during switching on to off or off to on. The generation of the electric arc may delay connection and disconnection of an electric circuit and even bum the electrical contacts, resulting in the melting and welding of the electrical contacts. In a severe case, it may cause ignition and explosion of the electric switch device having the electrical contacts. Therefore, an arc extinguishing device needs to be designed to achieve an efficient and reliable arc extinguishing effect.

In the relevant art, an electric switch device, such as a high-voltage direct current relay, usually uses a sealed inflatable magnetic field to lengthen a metal phase electric arc laterally, so that the electric arc may be cooled and deionized rapidly in an arc extinguishing medium. Such a method has a good arc extinguishing effect, but the manufacturing process thereof is complex, which results in a high cost. Another kind of arc extinguishing device is configured to blow the electric arc to a metal grid plate by magnetic blowing, and the electric arc is cut into several segments of short electric arcs by the metal grid plate, which enhances an initial dielectric strength of a gap between the segments of short electric arcs. In addition, the metal grid plate improves the cooling effect and the surface deionization effect.

However, the arc extinguishing speed of this arc extinguishing device is not ideal. Another kind of arc extinguishing device is configured to blow the electric arc to a metal grid plate by magnetic blowing, and the electric arc is cut into several segments of short electric arcs by the metal grid plate, which enhances an initial dielectric strength of a gap between the segments of short electric arcs. In addition, the metal grid plate improves the cooling effect and the surface deionization effect. However, the arc extinguishing speed of this arc extinguishing device is not ideal.

### SUMMARY

The present disclosure has been made to overcome or alleviate at least one aspect of the above mentioned disadvantages.

According to one object of the present disclosure, there is provided an electrical contact system that is capable of reliably extinguishing arc.

According to an aspect of the present disclosure, there is provided an electrical contact system including: a static contact; and a movable contact movable between a switch-on position where the movable contact is in electrical contact with the static contact and a switch-off position where the movable contact is separated from the static contact; and an arc extinguishing device. The arc extinguishing device includes: an arc extinguishing member; and a driving mechanism configured to drive the arc extinguishing member to move. When the movable contact is moved to the switch-on position, the arc extinguishing member is moved beyond a contact area between the movable contact and the static contact so as to allow the movable contact to be in electrical contact with the static contact; and when the movable contact is moved to the switch-off position, the arc extinguishing member is moved into the contact area between the movable contact and the static contact, such that the movable contact is electrically isolated from the static contact so as to cut off the electric arc between the movable contact and the static contact.

According to an exemplary embodiment of the present disclosure, the static contact includes a first static contact and a second static contact, and the movable contact is configured to be in electrical contact with the first static contact and the second static contact simultaneously.

According to another exemplary embodiment of the present disclosure, the arc extinguishing member includes a first arc extinguishing member and a second arc extinguishing member, and the driving mechanism is configured to simultaneously drive the first arc extinguishing member and the second arc extinguishing member to move.

According to another exemplary embodiment of the present disclosure, when the movable contact is moved to the switch-on position, the first arc extinguishing member is moved beyond the contact area between the movable contact and the first static contact so as to allow the movable contact to be in electrical contact with the first static contact; and when the movable contact is moved to the switch-on position, the second arc extinguishing member is moved beyond the contact area between the movable contact and the second static contact so as to allow the movable contact to be in electrical contact with the second static contact.

According to another exemplary embodiment of the present disclosure, when the movable contact is moved to the switch-off position, the first arc extinguishing member is moved into the contact area between the movable contact and the first static contact, such that the movable contact is electrically isolated from the first static contact so as to cut off the electric arc between the movable contact and the first static contact; and when the movable contact is moved to the switch-off position, the second arc extinguishing member is moved into the contact area between the movable contact and the second static contact such that the movable contact is electrically isolated from the second static contact so as to cut off the electric arc between the movable contact and the second static contact.

According to another exemplary embodiment of the present disclosure, the driving mechanism includes: a pair of supporting plates, each of which is formed with a first sliding slot and a second sliding slot; a pair of first pushing rods each of which is rotatably mounted at one end thereof to a corresponding supporting plate and is formed with a third sliding slot at the other end thereof; and a pair of second pushing rods each of which is rotatably mounted at one end thereof to a corresponding supporting plates, and is respectively formed with a fourth sliding slot at the other end thereof; a pair of first linkage shafts which are respectively inserted into two through holes in the first arc extinguishing member; and a pair of second linkage shafts which are respectively inserted into two through holes in the second arc extinguishing member. Two ends of each of the pair of first linkage shafts are respectively received in the first sliding slots of the pair of supporting plates, and two ends of one of the pair of first linkage shafts located on outer side are respectively received in the third sliding slots of the pair of first pushing rods. Two ends of each of the pair of second linkage shafts are respectively received in the second sliding slots of the pair of supporting plates, and two ends of one of the pair of second linkage shafts located on outer side are respectively received in the fourth sliding slots of the pair of second pushing rods.

According to another exemplary embodiment of the present disclosure, when the pair of first pushing rods are rotated about the one ends thereof, the pair of first pushing rods urge the first arc extinguishing member to move from an arc extinguishing position where the first arc extinguishing member is located in the contact area between the movable contact and the first static contact to a non-extinguishing position where the first arc extinguishing member is located beyond the contact area between the movable contact and the first static contact. When the pair of second pushing rods are rotated about the ends thereof, the pair of second pushing rods urge the second arc extinguishing member to move from an arc extinguishing position where the second arc extinguishing member is located in the contact area between the movable contact and the second static contact to a non-extinguishing position where the second arc extinguishing member is located beyond the contact area between the movable contact and the second static contact.

According to another exemplary embodiment of the present disclosure, the driving mechanism further includes: a pair of first return springs, each of which is connected at one end thereof to a corresponding supporting plate and is connected at the other end thereof to an end of the one of first linkage shafts located on outer side, so as to move the first arc extinguishing member from the non-extinguishing position to the arc extinguishing position; and a pair of second return springs, each of which is connected at one end thereof to a corresponding supporting plates and is connected at the other end thereof to an end of the one of the pair of second linkage shafts located on outer side so as to move the second arc extinguishing member from the non-extinguishing position to the arc extinguishing position.

According to another exemplary embodiment of the present disclosure, the first sliding slots and the second sliding slots both extend along arcuate paths, respectively. The pair of first linkage shafts are slidable along the arcuate path defined by the first sliding slots and the pair of second linkage shafts are slidable along the arcuate path defined by the second sliding slots.

According to another exemplary embodiment of the present disclosure, the third sliding slot and the fourth sliding slot both extend in a straight line. The one of the pair of first linkage shafts located on the outer side is slidable along the third sliding slot, and the one of the pair of second linkage shafts located on the outer side is slidable along the fourth sliding slot.

According to another exemplary embodiment of the present disclosure, the pair of first pushing rods are respectively pivotally connected at the end thereof to the pair of supporting plates via first articulating shafts; and the pair of second pushing rods are respectively pivotally connected at the end thereof to the pair of supporting plates via second articulating shafts.

In the foregoing exemplary embodiments of the present disclosure, the arc extinguishing member may be driven by the driving mechanism to be quickly moved into the contact area between the movable contact point and the static contact point, so that the electric arc between the movable contact point and the static contact point can be quickly cut off to achieve an efficient and reliable arc extinguishing effect. In addition, a simple structure and a low cost are achieved in the present disclosure.

### BRIEF DESCRIPTION OF THE DRAWINGS

The above and other features of the present disclosure will become more apparent by describing in detail exemplary embodiments thereof with reference to the accompanying drawings, in which:

FIG. 1 shows an exploded perspective view of an electrical contact system according to an embodiment of the present disclosure;

FIG. 2 shows an assembled perspective view of the electrical contact system according to an embodiment of the present disclosure; and

FIG. 3 shows a perspective view of the electrical contact system according to an embodiment of the present disclosure in which a movable and a static contact are removed.

### DETAILED DESCRIPTION OF EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In addition, in the following detailed description, for purpose of explanation, numerous specific details are set forth in order to provide a thorough understanding of the disclosed embodiments. However, it is apparent that one or more embodiments may also be implemented without these specific details, In other instances, well-known means and devices are schematically shown in the drawings to simplify the drawings.

According to a general technical concept of the present disclosure, there is provided an electrical contact system including: a static contact; a movable contact that is movable between a switch-on position where the movable contact is in electrical contact with the static contact and a switch-off position where the movable contact is separated from the static contact; and an arc extinguishing device including: an arc extinguishing member; and a driving mechanism configured to drive the arc extinguishing member to move. When the movable contact is moved to the switch-on position, the arc extinguishing member is moved beyond a contact area between the movable contact and the static contact allows such that the movable contact is allowed to be in electrical contact with the static contact; and when the movable contact is rotated to the switch-off position, the arc extinguishing member is moved into the contact area between the movable contact and the static contact, such that the movable contact is electrically isolated from the static contact so as to cut off the electric arc between the movable contact and the static contact.

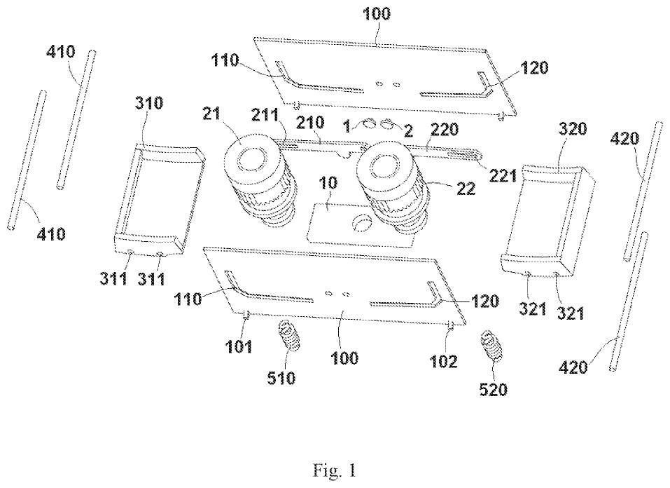

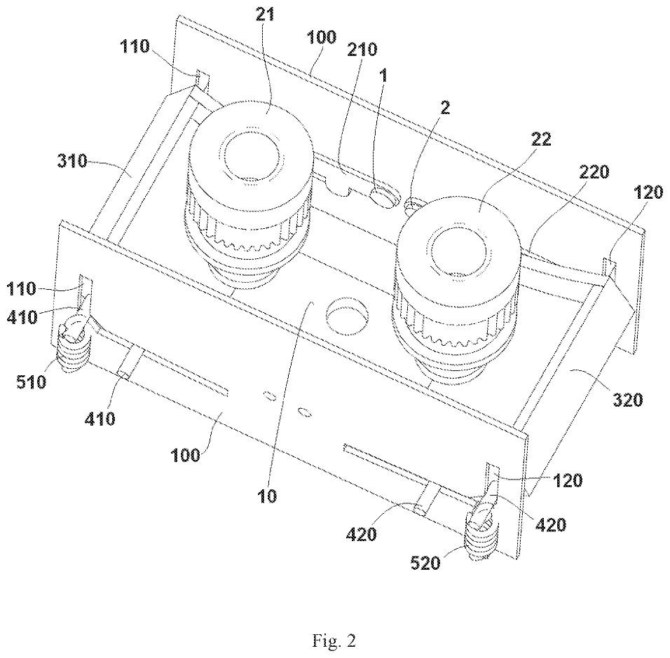

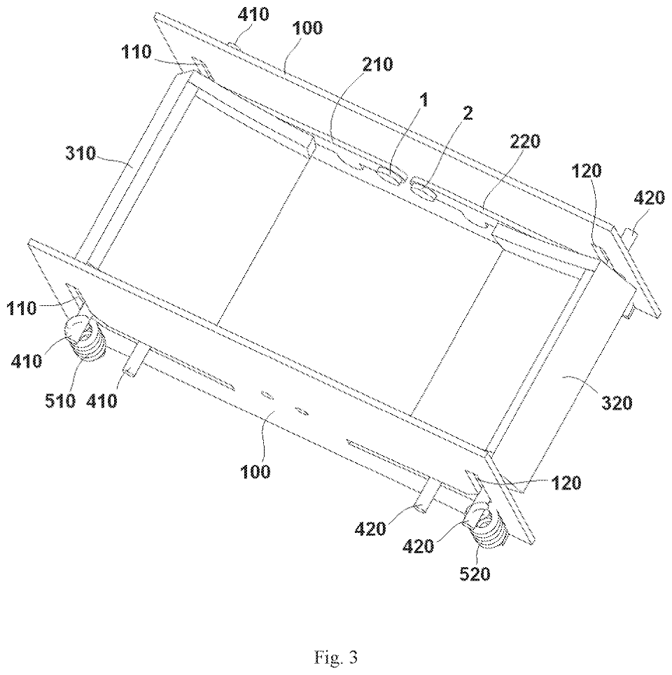

FIG. 1 shows an exploded perspective view of an electrical contact system according to an embodiment of the present disclosure; FIG. 2 shows the exploded perspective view of an electrical contact system according to an embodiment of the present disclosure; and FIG. 3 shows a perspective view of the electrical contact system according to an embodiment of the present disclosure in which a movable 10 and a static contact 21, 22 are removed.

As shown in FIGS. 1. 2 and 3, in the illustrated embodiment, the electrical contact system mainly includes: a movable contact 10, a static contact 21, 22 and an arc extinguishing device. The movable contact 10 is driven to be movable between a switch-on position where the movable contact 10 is in electrical contact with the static contact 21. and a switch-off position where the movable contact 10 is separated from the static contact 21, 22. The arc extinguishing device includes arc extinguishing member 310, 320 and a driving mechanism configured to drive the arc extinguishing member 310, 320 to move between an arc extinguishing position and a non-extinguishing position.

As shown in FIGS. 1, 2 and 3, in the illustrated embodiment, when the movable contact 10 is driven to move to the switch-on position, the arc extinguishing member 310, 320 is driven to move to the non-extinguishing position where the arc extinguishing member 310, 320 is located beyond the contact area between the movable contact 10 and the static contact 21, 22 so as to allow the movable contact 10 to be in electrical contact with the static contact 21, 22.

As shown in FIGS. 1, 2 and 3, in the illustrated embodiment, when the movable contact 10 is driven to move to the switch-off position, the arc extinguishing member 310, 320 is driven to move to the arc extinguishing position where the arc extinguishing member 310, 320 is located in the contact area between movable contact 10 and the static contact 21, 22. Then, the movable contact 10 is electrically isolated from the static contact 21, 22 by the arc extinguishing member 310, 320 so as to cut off the electric arc between the movable contact 10 and the static contact 21, 22.

As shown in FIGS. 1, 2 and 3, in the illustrated embodiment, the static contact 21, 22 includes a first static contact 21 and a second static contact 22. The movable contact 10 is configured to be in electrical contact with the first static contact 21 and the second static contact 22 simultaneously. That is, the illustrated electrical contact system is constructed as a dual contact electrical contact system.

As shown in FIGS. 1, 2 and 3, in the illustrated embodiment, the arc extinguishing member 310, 320 includes a first arc extinguishing member 310 and a second arc extinguishing member 320. The driving mechanism is configured to simultaneously drive the first arc extinguishing member 310 and the second arc extinguishing member 320 to be moved between the arc extinguishing position and the non-extinguishing position.

As shown in FIGS. 1, 2 and 3, in the illustrated embodiment, when the movable contact 10 is moved to the switch-on position, the first arc extinguishing member 310 is driven to move to the non-extinguishing position where the first arc extinguishing member 310 is located beyond the contact area between the movable contact 10 and the first static contact 21, such that the movable contact 10 is allowed to be in electrical contact with the first static contact 21. Likewise, when the movable contact 10 is moved to the switch-on position, the second arc extinguishing member 320 is driven to move to the non-extinguishing position where the second arc extinguishing member 320 are located beyond the contact area between the movable contact 10 and the second static contact 22, such that the movable contact 10 is allowed to be in electrical contact with the second static contact 22.

As shown in FIG. 1, FIG. 2 and FIG. 3, in the illustrated embodiment, when the movable contact 10 is rotated to the switch-off position, the first arc extinguishing member 310 is driven to move to the arc extinguishing position where the first arc extinguishing member 310 are located in the contact area between the movable contact 10 and the first static contact 21, such that the movable contact 10 is electrically isolated from the first static contact 21 to cut off the electric arc between the movable contact 10 and the first static contact 21. Likewise, when the movable contact 10 is rotated to the switch-off position, the second arc extinguishing member 320 is moved to the arc extinguishing position where the second arc extinguishing member 320 are located in the contact area between the movable contact 10 and the second static contact 22, such that the movable contact 10 is electrically isolated from the second static contact 22 to cut off the electric arc between the movable contact 10 and the second static contact 22.

As shown in FIGS. 1, 2 and 3, in the illustrated embodiment, the driving mechanism mainly includes: a pair of supporting plates 100, a pair of first pushing rods 210, a pair of second pushing rods 220, a pair of first linkage shafts 410 and a pair of second linkage shafts 420.

As shown in FIGS. 1, 2 and 3, in the illustrated embodiment, a first sliding slot 110 and a second sliding slot 120 are formed in each supporting plate 100, Each of the pair of first pushing rods 210 is rotatably mounted at one end thereof (right end in FIG. 1) to a corresponding supporting plate 100, and is formed with a third sliding slot 211 at the other end thereof (left end in FIG. 1). Each of the pair of second pushing rods 220 is rotatably mounted at one end thereof (left end in FIG. 1) to a corresponding supporting plate 100 and is formed with a fourth sliding slot 221 at the other end (right end in FIG. 1). The pair of first linkage shafts 410 are respectively inserted into two through holes 311 in the first arc extinguishing member 310. The pair of second linkage shafts 420 are respectively inserted into two through holes 321 in the second arc extinguishing member 320.

As shown in FIGS. 1, 2 and 3, in the illustrated embodiment, two ends of each of the pair of first linkage shafts 410 are respectively received in the first sliding slots 110 of the pair of supporting plates 100, and two ends of one of the pair of first linkage shafts 410 located on outer side are respectively further received in the third sliding slots 211 of the pair of first pushing rods 210. Two ends of each of the pair of second linkage shafts 420 are respectively received in the second sliding slots 120 of the pair of supporting plates 100, and two ends of one of the pair of second linkage shafts 420 located on outer side are respectively further received in the fourth sliding slots 221 of the pair of second pushing rods 220.

As shown in FIGS. 1, 2 and 3, in the illustrated embodiment, when the pair of first pushing rods 210 are rotated about the ends thereof (right end in FIG. 1) under the action of an external pushing force (for example, a magnetic thrust force), the pair of first pushing rods 210 drive the first arc extinguishing member 310 to move from the arc extinguishing position where the first arc extinguishing member 310 is located in the contact area between the movable contact 10 and the first static contact 21 to the non-extinguishing position where the first arc extinguishing member 310 is located beyond contact area between the movable contact 10 and the first static contact 21. Likewise, when the pair of second pushing rods 220 are rotated about the ends thereof (left end in FIG. 1) under the action of an external pushing force (for example, magnetic thrust force), the pair of second pushing rods 220 drive the second arc extinguishing member 320 to move from the arc extinguishing position where the second arc extinguishing member 320 is located in the contact area between the movable contact 10 and the second static contact 22 to a non-extinguishing position where the second arc extinguishing member 320 is located beyond the contact area between the movable contact 10 and the second static contact 22.

As shown in FIGS. 1, 2 and 3, in the illustrated embodiment, the driving mechanism further includes a pair of first return springs 510 and a pair of second return springs 520. Each of the pair of first return springs 510 is connected at one end thereof (lower end in FIG. 1) to a corresponding supporting plate 100 and is connected at the other end thereof (upper end in FIG. 1) to an end of the one of the pair of first linkage shafts 410 located on outer side. When the pushing force applied to the pair of first pushing rods 210 disappears, the first arc extinguishing member 310 is automatically moved from the non-extinguishing position to the arc extinguishing position under the action of the elastic restoring force of the pair of first return springs 510. Likewise, Each of the pair of second return springs 520 is connected at an end thereof (lower end in FIG. 1) to a corresponding supporting plates 100 and is connected at the other end thereof (upper end in FIG. 1) to an end of the one of the pair of second linkage shafts 420 located on outer side. When the pushing force applied to the pair of second pushing rods 220 disappears, the second arc extinguishing member 320 is automatically moved from the non-extinguishing position to the arc extinguishing position under the action of the elastic restoring force of the pair of second return springs 520.

As shown in FIGS. 1, 2 and 3, in the illustrated embodiment, the first sliding slots 110 and the second sliding slots 120 both extend along arcuate paths, respectively. The pair of first linkage shafts 410 are slidable along the arcuate path defined by the first sliding slots 110, and the pair of second linkage shafts 420 are slidable along the arcuate path defined by the second sliding slots 120.

As shown in FIGS. 1, 2 and 3, in the illustrated embodiment, the third sliding slots 211 in the pair of first pushing rods 210 and the fourth sliding slots 221 in the pair of second pushing rods 220 both extend straightly. The one of the pair of first linkage shafts 410 located on the outer side is slidable along the third sliding slots 211 in the pair of first pushing rods 210, and the one of the pair of second linkage shafts 420 located on the outer side is slidable along the fourth sliding slots 221 in the pair of second pushing rods 220.

As shown in FIGS. 1, 2 and 3, in the illustrated embodiment, the pair of first pushing rods 210 are pivotally connected at the ends thereof (right ends in FIG. 1) to the pair of supporting plates 100 via first articulating shafts 1, respectively. The pair of second pushing rods 220 are pivotally connected at the ends thereof (left ends in FIG. 1) to the pair of supporting plates 100 via second articulating shafts 2, respectively.

In the foregoing exemplary embodiments of the present disclosure, the arc extinguishing member may be driven by the pushing rods to be quickly moved to the arc extinguishing position where the arc extinguishing member are located in the contact area between the movable contact point and the static contact point, so that the electric arc between the movable contact point and the static contact point may be quickly cut off to achieve an efficient and reliable arc extinguishing effect. In addition, a simple structure and a low cost are achieved in the present disclosure.

In the foregoing embodiments of the present disclosure, the mechanism of the overall electrical contact system is very simple, which facilitates manufacturing and assembling and is high reliable. Moreover, the size of the overall electrical contact system may be miniaturized, the overall electrical contact system requires less drive energy, has low energy consumption, and may realize reliable connection and disconnection of an electric circuit having the electrical contact system.

Those skilled in the art can understand that the above-described embodiments are all exemplary, and those skilled in the art can improve it. The structures described in the various embodiments can be freely combined without a conflict in structure or principle.

Although the present disclosure has been described with reference to the accompanying drawings, the embodiments disclosed in the accompanying drawings are intended to illustrate the preferred embodiments of the present disclosure exemplarily, and cannot be construed as a limitation of the present disclosure.

Although some embodiments according to the present general inventive concept have been shown and described, those of ordinary skill in the art will understand that modifications may be made to these embodiments without departing from the principle and spirit of the present general inventive concept. The scope of the disclosure is defined by the claims and their equivalents.

It should be noted that the wording “including/comprising” does not exclude other elements or steps, and the wording “a” or “an” does not exclude a plurality. In addition, any reference numerals in a claim should not be construed as limiting the scope of the present disclosure.

What is claimed is,:

1. An electrical contact system comprising:
a static contact (21, 22);
a movable contact (10) movable between a switch-on position where the movable contact (10) is in electrical contact with the static contact (21, 22) and a switch-off position where the movable contact (10) is separated from the static contact (21, 22); and
an arc extinguishing device comprising:
an arc extinguishing member (310, 320); and
a driving mechanism configured to drive the arc extinguishing member (310, 320) to move,
wherein when the movable contact (10) is moved to the switch-on position, the arc extinguishing member (310, 320) is moved beyond a contact area between the movable contact (10) and the static contact (21, 22), such that the movable contact (10) is allowed to be in electrical contact with the static contact (21, 22); and
wherein when the movable contact (10) is moved to the switch-off position, the arc extinguishing member (310, 320) is moved into the contact area between the movable contact (10) and the static contact (21, 22). such that the movable contact (10) is electrically isolated from the static contact (21, 22) to cut off the electric arc between the movable contact (10) and the static contact (21, 22).

2. The electrical contact system of claim 1,
wherein the static contact (21, 22) comprises a first static contact (21) and a second static contact (22), and the movable contact (10) is configured to be in electrical contact with the first static contact (21) and the second static contact (22) simultaneously.

3. The electrical contact system of claim 2,
wherein the arc extinguishing member (310, 320) comprises a first arc extinguishing member (310) and a second arc extinguishing member (320), and the driving mechanism is configured to simultaneously drive the first arc extinguishing member (310) and the second arc extinguishing member (320) to move.

4. The electrical contact system of claim 3,
wherein when the movable contact (10) is moved to the switch-on position, the first arc extinguishing member (310) is moved beyond the contact area between the movable contact (10) and the first static contact (21) to allow the movable contact (10) to be in electrical contact with the first static contact (21); and
wherein when the movable contact (10) is moved to the switch-on position, the second arc extinguishing member (320) is moved beyond the contact area between the movable contact (10) and the second static contact (22) to allow the movable contact (10) to be in electrical contact with the second static contact (22).

5. The electrical contact system of claim 3.
wherein when the movable contact (10) is moved to the switch-off position, the first arc extinguishing member (310) is moved into the contact area between the movable contact (10) and the first static contact (21), such that the movable contact (10) is electrically isolated from the first static contact (21) to cut off the electric arc between the movable contact (10) and the first static contact (21); and
wherein when the movable contact (10) is moved to the switch-off position, the second arc extinguishing member (320) is moved into the contact area between the movable contact (10) and the second static contact (22), such that the movable contact (10) is electrically isolated from the second static contact (22) to cut off the electric arc between the movable contact (10) and the second static contact (22).

6. The electrical contact system of claim 3,
wherein the driving mechanism comprises:
a pair of supporting plates (100) each of which is formed with a first sliding slot (110) and a second sliding slot (120);
a pair of first pushing rods (210) each of which is rotatably mounted at one end thereof to a corresponding supporting plate (100) and is formed with a third sliding slot (211) at the other end thereof;
a pair of second pushing rods (220) each of which is rotatably mounted at one end thereof to a corresponding supporting plate (100), and is formed with a fourth sliding slot (221) at the other end thereof;
a pair of first linkage shafts (410) which are respectively inserted into two through holes (311) in the first arc extinguishing member (310); and
a pair of second linkage shafts (420) which are respectively inserted into two through holes (321) in the second arc extinguishing member (320);
wherein two ends of each of the pair of first linkage shafts (410) are respectively received in the first sliding slots (110) of the pair of supporting plates (100), and two ends of one of the pair of first linkage shafts (410) located on outer side are respectively received in the third sliding slots (211) of the pair of first pushing rods (210); and
wherein two ends of each of the pair of second linkage shafts (420) are respectively received in the second sliding slots (120) of the pair of supporting plates (100), and two ends of one of the pair of second linkage shafts (420) located on outer side are respectively received in the fourth sliding slots (221) of the pair of second pushing rods (220).

7. The electrical contact system of claim 6,
wherein when the pair of first pushing rods (210) are rotated about the ends thereof, the pair of first pushing rods (210) drive the first arc extinguishing member (310) to move from an arc extinguishing position where the first arc extinguishing member (310) is located in the contact area between the movable contact (10) and the first static contact (21) to a non-extinguishing position where the first arc extinguishing member (310) is located beyond the contact area between the movable contact (10) and the first static contact (21); and
wherein when the pair of second pushing rods (220) are rotated about the ends thereof, the pair of second pushing rods (220) drive the second arc extinguishing member (320) to move from an arc extinguishing position where the second arc extinguishing member (320) is located in the contact area between the movable contact (10) and the second static contact (22) to a non-extinguishing position where the second arc extinguishing member (320) is located beyond the contact area between the movable contact (10) and the second static contact (22).

8. The electrical contact system of claim 7, wherein the driving mechanism further comprises:
a pair of first return springs (510) each of which is connected at one end thereof to a corresponding supporting plate (100) and is connected at the other end thereof to an end of the one of the pair of first linkage shafts (410) located on outer side so as to move the first arc extinguishing member (310) from the non-extinguishing position to the arc extinguishing position; and
a pair of second return springs (520) each of which is connected at one end thereof to a corresponding supporting plates (100) and is connected at the other end thereof to an end of the one of the pair of second linkage shafts (420) located on outer side so as to move the second arc extinguishing member (320) from the non-extinguishing position to the arc extinguishing position.

9. The electrical contact system of claim 6,
wherein the first sliding slots (110) and the second sliding slots (120) both extend along arcuate paths, respectively; and
wherein the pair of first linkage shafts (410) are slidable along the arcuate path defined by the first sliding slots (110), and the pair of second linkage shafts (420) are slidable along the arcuate path defined by the second sliding slots (120).

10. The electrical contact system of claim 9,
wherein the third sliding slot (211) and the fourth sliding slot (221) both extend straightly, and
wherein the one of the pair of first linkage shafts located on the outer side is slidable along the third sliding slot (211), and the one of the pair of second linkage shafts (420) located on the outer side is slidable along the fourth sliding slot (221).

11. The electrical contact system of claim 6,
wherein the pair of first pushing rods (210) are respectively pivotally connected at the ends thereof to the pair of supporting plates (100) via first articulating shafts (1); and
wherein the pair of second pushing rods (220) are respectively pivotally connected at the end thereof to the pair of supporting plates (100) via second articulating shafts (2).
